(19) United States
(12) Patent Application Publication
(10) Pub. No.: US 2025/0058362 A1
(43) Pub. Date: Feb. 20, 2025

(54) CLEANING BRUSH FOR HULL

(71) Applicant: TAS GLOBAL CO., LTD., Busan (KR)

(72) Inventor: Dong Wook LEE, Busan (KR)

(21) Appl. No.: 18/720,652

(22) PCT Filed: Dec. 16, 2022
(86) PCT No.: PCT/KR2022/020655

§ 371 Date: Jun. 16, 2024

(30) Foreign Application Priority Data
Dec. 17, 2021 (KR) 10-2021-0181518
May 2, 2022 (KR) 10-2022-0054077

(51) Int. Cl. B08B 1/32; B08B 1/12; B08B 13/00

(52) U.S. Cl. CPC B08B 1/32; B08B 1/12; B08B 13/00

(57) ABSTRACT

A cleaning brush for a hull according to embodiments includes: a base material; a fixing part coupled to a lower end part of the base material and having a fixing protrusion that protrudes from an outside of the base material; and a rotation body part having at least one fixing groove into which the fixing part coupled to the base material is to be inserted, in which the base material is replaceable.

### CROSS REFERENCE TO RELATED APPLICATIONS

This application is a National Stage Entry of International Patent Application No. PCT/KR2022/020655, filed on Dec. 16, 2022, which claims priority from and the benefit of Korean Patent Application No. 10-2021-0181518, filed on Dec. 17, 2021, and Korean Patent Application No. 10-2022-0054077, filed on May 2, 2022, each of which is hereby incorporated by reference for all purposes as if fully set forth herein.

### BACKGROUND

### Field

Embodiments of the present invention relate to a cleaning brush for a hull, and more specifically, to a cleaning brush installed with a rotational base material to remove a contaminant on a surface of a hull, the contaminant including marine organisms such as slime, marine plants, barnacles, or mussels, by using pressure and friction from the rotation of the base material.

### Discussion of Background

Even newly built ships have various marine organisms adhering to lower surfaces of hulls (hereafter referred to as hull surfaces) from the moment the ships touch seawater. Various marine organisms, such as slime to marine plants, barnacles, or mussels adhere to the hull surfaces, and depending on the amount of adhering, a movement speed of a ship is decreased whereas its fuel expenditure is increased by 10% to 30%. Hence, the hull surfaces need to be cleaned.

In order to prevent marine organisms from adhering to the hull surfaces, the hull surfaces are coated with antifouling paint, but this coating merely delays the time for marine organisms to adhere the hull surfaces. After about one year, organisms such as barnacles or mussels, which significantly increase the resistance of water, form a colony and adhere to the hull surfaces.

In order to remove marine organisms adhering to the hull surfaces, divers or ship cleaning robots have been cleaning the hull surfaces using cleaning brushes that rotate automatically by motors.

Conventional cleaning brushes for a hull are broadly divided into disk-shaped cleaning brushes that have a filament-shaped base material installed on one side of a rotating disk, and roller-shaped cleaning brushes that have a filament-shaped base material installed on a surface of a long rotating cylinder.

In general, biofouling levels of hull surfaces can be arbitrarily categorized into four levels as follows, where a higher level includes biofouling in a lower level).

Level 1: Slime or moss

Level 2: Marine plants

Level 3: Small colonies of hard-shelled creatures

Level 4: Large colonies of hard-shelled creatures

In order to minimize a degree of biofouling and damage to antifouling paint of hull surfaces, soft cleaning brushes utilizing only plastic base materials, middle cleaning brushes utilizing a mixture of a metal base material and a plastic base material, and hard cleaning brushes utilizing only a metal base material have been used selectively.

For example, the hard cleaning brushes are used when there is little antifouling paint in level 4 biofouling, the middle cleaning brushes are used when no problem arises even if antifouling paint is severely damaged in level 3 biofouling, and the soft cleaning brushes are used in levels 1 and 2 biofouling and cause very little damage to antifouling paint during cleaning.

Repainting of antifouling paint takes much time and money, so it is important to use the antifouling paint for as long as possible. In order to use the antifouling paint for a long time, it is especially necessary to provide a cleaning brush that can minimize damage to the antifouling paint during cleaning a surface of a ship in levels 1 to 3 biofouling.

To remove the organisms having hard shells in level 3 biofouling, it is possible to easily remove organisms by applying a weak impact to upper parts of the shells instead of lower parts of the shells. In order to apply a weak impact, a stiff base material is generally used, but existing filament-shaped base materials have a problem in that tips of the base materials come into point contact with the antifouling paint and scratch it, thereby causing damage thereto.

In addition, cleaning brushes have been manufactured in a manner of implanting the existing filament-shaped base materials into a surface of a rotating disk or rotating cylinder. However, when the base materials wear out and need replacement, the worn-out base materials need to be removed and new base materials need to be implanted again using specialized equipment.

Hence, there is a demand for a cleaning brush for a hull, which can be used in various biofouling situations of surfaces of ships, minimizes damage to antifouling paint during cleaning, and facilitates replacement of a base material.

### SUMMARY

The inventive concepts are directed to a cleaning brush for a hull, in which a base material can be mounted in a rotation body part by inserting a fixing part coupled to the base material into a fixing groove of the rotation body part, such that the base material can be easily replaced and used. In this manner, damage to antifouling paint is minimized during cleaning by using a block-shaped base material rather than a filament-shaped base material, and base materials having various shapes and qualities can be mixed and easily mounted.

Additional features of the inventive concepts will be set forth in the description which follows, and in part will be apparent from the description, or may be learned by practice of the inventive concepts.

According to an embodiment, a cleaning brush for a hull is capable of removing a contaminant on a surface of a hull, the cleaning brush including: a base material; a fixing part coupled to a lower end part of the base material and having a fixing protrusion which is formed therein and protrudes to the outside of the base material; and a rotation body part that rotates and having one or more fixing grooves into which the fixing part coupled to the base material is inserted, in which the base material is replaceable.

The rotation body part may be formed in a shape of a disk, and the fixing grooves may be formed in a shape open at a side surface part and an upper surface of the rotation body part, such that the fixing part coupled to the base material is inserted inward in a radial direction from a side surface of the disk to allow the base material to protrude from an upper surface of the disk.

The rotation body part may be formed in a shape of a cylinder, and the fixing grooves may be formed in a shape open at an outer surface and an edge of at least one surface of upper and lower surfaces of the cylinder of the rotation body part, such that the fixing part coupled to the base material is inserted in a height direction of the cylinder from any one surface of the upper and lower surfaces of the cylinder to allow the base material to protrude from an outer surface of the cylinder.

The fixing grooves may be a fixing protrusion inserting groove into which the fixing protrusion is inserted in a direction from which the fixing part coupled to the base material is inserted, and a base material inserting groove into which the lower end part of the base material is inserted and may be formed in a cross shape.

The base material may be formed in a shape of a block or formed by overlapping a plurality of plates.

The lower end part of the base material may have at least one penetration hole, and the fixing part may have a fixing protrusion which is inserted into the hole and protrudes toward both sides from the hole.

The fixing part may have a bar-shaped first frame, and at least one bar-shaped second frame which extends in a direction orthogonal to the first frame, is inserted into the hole, and protrudes to an outer side from the base material.

The base material may include either a polyurethane class or a nylon class.

The cleaning brush for a hull may further include a strip brush including a base material having a symmetrically bent shape, a holding frame surrounding a bent lower end part of the base material, and a core pressurizing a bent inner side of the base material, and the fixing part may be coupled to a lower end part of the strip brush.

The fixing part may have an accommodation part that surrounds an outer side of the holding frame and has an upper end part bent above the holding frame, and the fixing protrusion may protrude toward both sides from an outer surface of the accommodation part.

The strip brush may be either a filament-shaped strip brush or a sponge-like strip brush.

The fixing part may be separated into right and left parts.

Base materials having shapes different from each other and including materials different from each other may be inserted into a plurality of fixing grooves, respectively.

Base materials having shapes different from each other and including materials different from each other may be inserted into the fixing grooves, respectively, along on insertion directions of the fixing grooves.

A surface of the base material may be coated with powder having a high hardness.

The base material may include powder having a high hardness.

The powder may include carbon or metal.

The cleaning brush for a hull according to embodiments of the present invention includes a base material that can be easily replaced and mounted.

The cleaning brush according to embodiments is capable of reducing antifouling paint during cleaning of a hull surface by using a base material made of a flexible material having a high hardness in a shape of a block or overlapped plates.

The cleaning brush according to embodiments is capable of being installed with various combinations of base materials that are made of various materials and have various shapes, such as a block-shaped base material and a strip brush-shaped base material, which also can be replaced and installed, thereby facilitating a hull surface cleaning without replacing the base materials regardless of biofouling levels.

### BRIEF DESCRIPTION OF THE DRAWINGS

FIG. 1 is a perspective view of a cleaning brush for a hull according to a first embodiment of the present invention.

FIG. 2 is an exploded perspective view illustrating a state where a base material is separated from the cleaning brush shown in FIG. 1.

FIG. 3 is a perspective view illustrating coupling relationships between a fixing part and a block-shaped base material and a plate-shaped base material, respectively.

FIG. 4 is a perspective view of a cleaning brush for a hull according to a second embodiment of the present invention.

FIG. 5 is an exploded perspective view illustrating a state where a base material is separated from the cleaning brush shown in FIG. 4.

FIG. 6 is a perspective view of a cleaning brush for a hull according to a third embodiment of the present invention.

FIG. 7 is an exploded perspective view illustrating a state where a strip brush is separated from the cleaning brush shown in FIG. 6.

FIG. 8 illustrates a perspective view and a side view of a coupling state between a filament-shaped strip brush and a fixing part.

FIG. 9 illustrates a perspective view and a side view of a separation state between the filament-shaped strip brush and the fixing part shown in FIG. 8.

FIG. 10 illustrates a perspective view and a side view of a coupling state between a fixing part and a sponge-like strip brush as a modification example of the filament-shaped strip brush shown in FIG. 8.

FIG. 11 illustrates an exploded perspective view and a coupling view of a cleaning brush for a hull according to a fourth embodiment of the present invention.

FIG. 12 illustrates an exploded perspective view and a coupling view of a cleaning brush for a hull according to another embodiment.

### DETAILED DESCRIPTION

The specific details of embodiments are included in the detailed descriptions and drawings.

Advantages, features, and methods of achieving the advantages and the features are to be more clearly described with reference to embodiments to be described below in detail together with the accompanying drawings. However, the present invention is not limited to the embodiments to be described hereinafter, but can be realized as various embodiments different from each other. The embodiments are only provided to complete the disclosure of the present invention and completely inform those with ordinary skill in the art to which the present invention pertains of the scope of the present invention, and the present invention is only defined by the scope of the claims. Through the entire specification, the same reference numerals denote the same configurational elements, respectively.

Hereinafter, the present invention will be described with reference to the drawings for describing a cleaning brush for a hull on the basis of the embodiments of the present invention.

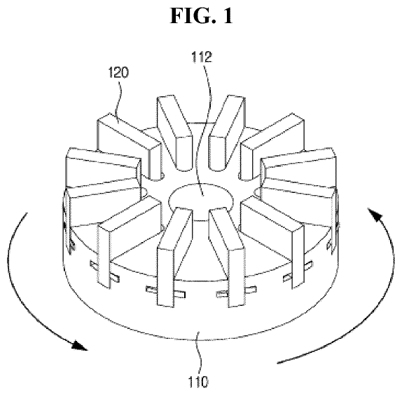

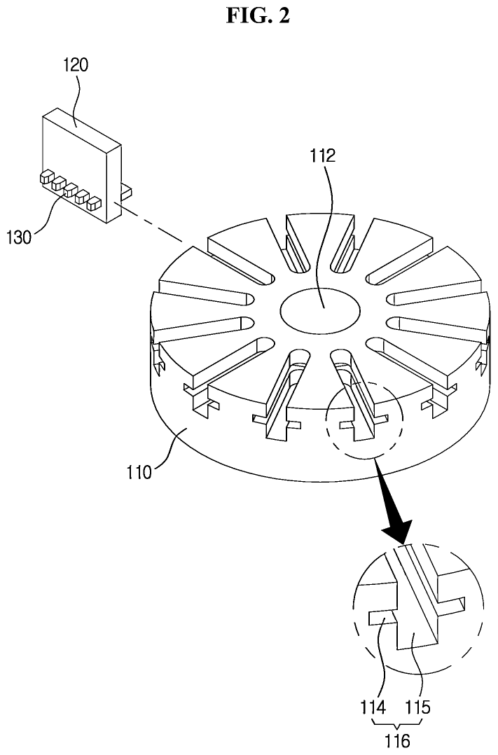

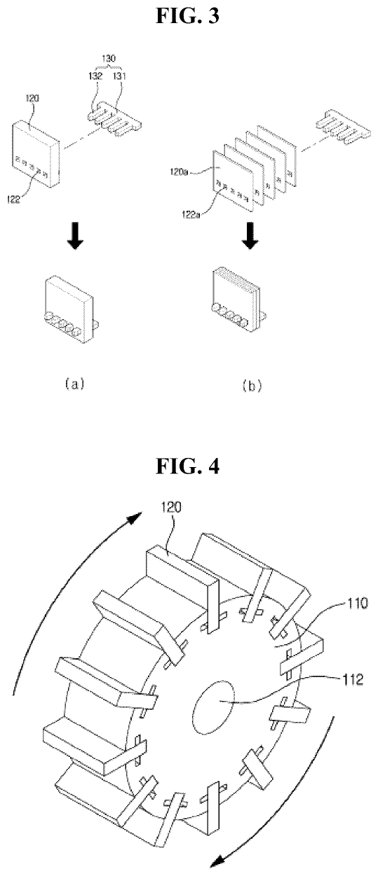

FIG. 1 is a perspective view of a cleaning brush for a hull according to a first embodiment of the present invention, FIG. 2 is an exploded perspective view illustrating a state where a base material is separated from the cleaning brush shown in FIG. 1, and FIG. 3 is a perspective view illustrating coupling relationships between a fixing part and a block-shaped base material and a plate-shaped base material, respectively.

The cleaning brush for a hull according to the first embodiment of the present invention may include a base material 120, a fixing part 130, and a rotation body part 110.

The rotation body part 110 receives power from a motor and rotates, and at least one base material 120 is fixed thereto. In the present embodiment, the rotation body part 110 has a circular disk shape with a predetermined thickness, and the base material 120 may be coupled to the rotation body part 110 to protrude from an upper surface of the disk-shaped rotation body part 110.

As illustrated in the drawings, the rotation body part 110 has, at a center thereof, a coupling hole 112 to which a motor shaft or a rotary shaft that receives power from a motor and rotates is inserted and coupled.

The rotation body part 110 may have one or more fixing grooves 116 to which the base material 120 can be coupled. More specifically, as will be described in more detail below, the base material 120 is coupled to the fixing part 130, and the fixing part 130 may be inserted into the fixing groove 116 to be coupled to the rotation body part 110.

In the present embodiment, the fixing groove 116 can be formed in a shape open at an upper end part of a side surface and an upper surface of the rotation body part 110, such that the fixing part 130 coupled to the base material 120 may be inserted into the fixing groove 116 from the upper end part of the side surface of the rotation body part 110. In this manner, the base material 120 protrudes from the upper surface of the rotation body part 110. At this time, as will described below, the base material 120 may be formed in a shape of a long block with a predetermined thickness, so that the fixing groove 116 may extend deep inward in a radial direction of the rotation body part 110.

The base material 120 is coupled to the rotation body part 110 and removes contaminants on a hull surface by applying pressure or friction through rotation of the rotation body part 110. As illustrated in (a) of FIG. 3, the base material 120 according to an embodiment may be formed in a shape of a block. The base material 120 can be formed as a block having a rectangular parallelepiped shape with a predetermined height and a predetermined thickness, and longitudinally extends along one direction. However, the inventive concepts are not limited thereto, and the shape of the base material 120 may be varied. For example, the base material 120 may be formed to have a block shape as illustrated in (a) of FIG. 3 by stacking a plurality of plate-shaped base materials 120a as illustrated in (b) of FIG. 3.

In a conventional filament-shaped base material, a stiff base material needs to be used in order to easily remove contaminants having hard shells of level 3 or higher biofouling. In this case, an end part of the conventional base material comes into point contact with antifouling paint and scratches the antifouling paint, thereby easily damaging the antifouling paint. Accordingly, according to an embodiment of the present invention, the base material 120 is formed in the shape of a block as illustrated in FIG. 3, such that the base material 120 comes into line contact or surface contact with the antifouling paint. In this manner, damages to the antifouling paint during cleaning can be minimized even when the stiff base material 120 is used.

According to an embodiment, the base material 120 may include a material having high hardness while can be flexibly bent when force is applied. For example, the base material 120 may be made of a polyurethane class or a nylon class, but is not necessarily limited thereto. The base material 120 may formed by mixing metal or may include a metal material to be used in cleaning level 4 biofouling.

The fixing part 130 may have a fixing protrusion that is coupled to a lower end part of the base material 120 and protrudes to the outside of the base material 120. The fixing part 130 coupled to the base material 120 may be inserted into the fixing groove 116 and fixed to the rotation body part 110.

The base material 120 may have at least one through-holes 122 at a lower end part thereof, and the fixing part 130 may have fixing protrusions which are inserted into the through-holes 122 to be coupled to the base material 120 and to protrude toward both sides from the through-holes 122.

In the present embodiment, the fixing part 130 may include a bar-shaped first frame 131 and at least one bar-shaped second frames 132 extending in a bar shape in a direction orthogonal to the first frame 131. A plurality of second frames 132 may be spaced apart from each other at regular intervals. The base material 120 may include at least one through-holes 122 at the lower part thereof, into which the second frame 132 is inserted and penetrates the base material 120. In an embodiment, the number of the second frames 132 may be greater than the number of the through-holes 122 formed in the base material 120. In this case, the base material 120 may be coupled to the fixing part 130 by selecting any position of the fixing part 130, or a plurality of the base materials 120 may be coupled to a single fixing part 130.

When the second frame 132 of the fixing part 130 is inserted into the through-hole 122 and couple to the base material 120, an end part of the second frame 132 protrudes to the outside of the base material 120, and the protruding end part of the second frame 132 may form a fixing protrusion. In addition, when the fixing part 130 is coupled to the base material 120, the first frame 131 protrudes to the outside of the base material 120, and the first frame 131 may form fixing protrusions on opposite sides.

The fixing groove 116 formed in the rotation body part 110 may include fixing protrusion inserting grooves 114 into which the fixing protrusions on both sides of the base material 120 are inserted. As illustrated in the enlarged view of FIG. 2, the fixing protrusion inserting grooves 114 and a base material inserting groove 115 into which the lower end part of the base material 120 is inserted may form a cross-shape. A plurality of fixing grooves 116 are formed in a circumferential direction of the disk-shaped rotation body part 110 so that a plurality of base materials 120 can be coupled thereto.

According to some embodiment, a locking part blocking side surfaces of the fixing grooves 116 can be formed to prevent the fixing part 130 coupled to the base material 120 from escaping in a direction opposite to the insertion after the fixing part 130 is inserted into the fixing groove 116. The locking part can be formed in a shape of a cap covering an outer surface of the rotation body part 110 to block the side surfaces of the plurality of fixing grooves 116 in the circumferential direction.

As described above, in the cleaning brush for a hull according to embodiments, the fixing parts 130 coupled to the base materials 120 are inserted into and coupled to the fixing grooves 116, so that the base material 120 can be easily replaced and installed with a new base material when the base material 120 is worn out during use.

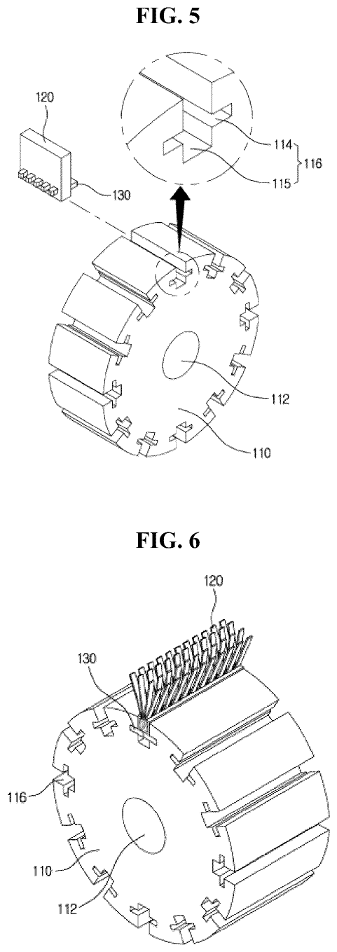

FIG. 4 is a perspective view of a cleaning brush for a hull according to a second embodiment, and FIG. 5 is an exploded perspective view illustrating a state where a base material is separated from the cleaning brush shown in FIG. 4.

The cleaning brush for a hull according to the second embodiment is substantially similar to that described in the first embodiment. As such, repeated descriptions of substantially the same elements will be omitted to avoid redundancy, and the following description focuses on differences from the first embodiment described above.

In the present embodiment, the rotation body part 110 is formed in a shape of a cylinder, and the base material 120 may be formed to protrude from the outer surface of the cylinder. In particular, the fixing groove 116 according to this embodiment may be formed in a shape open at an outer surface of the cylinder and an edge of at least one surface of upper and lower surfaces of the cylinder of the rotation body part 110. In this manner, the fixing part 130 coupled to the base material 120 can be inserted in a height direction of the cylinder from any one surface of the upper and lower surfaces of the cylinder, such that the base material 120 protrudes from an outer surface of the cylinder of the rotation body part 110. In the drawings, the fixing grooves 116 are formed in a shape open at both the upper and lower surfaces of the cylinder, but the inventive concepts are not limited thereto, and in some embodiments, the fixing grooves 116 can be formed in a shape having one blocked surface.

A plurality of fixing grooves 116 are formed to be spaced apart along the circumferential direction, and a plurality of base materials 120 can be coupled to the outer surface of the cylinder of the rotation body part 110 in the circumferential direction.

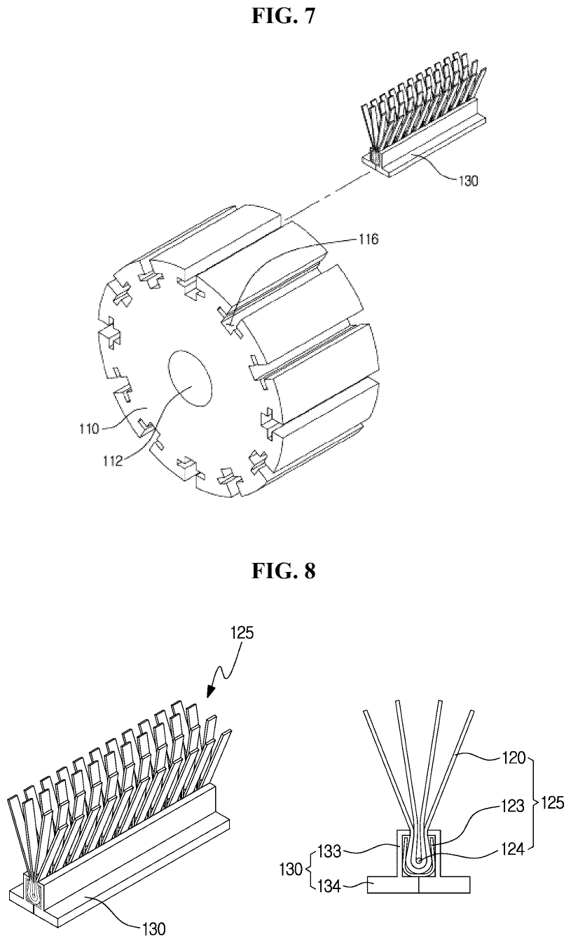

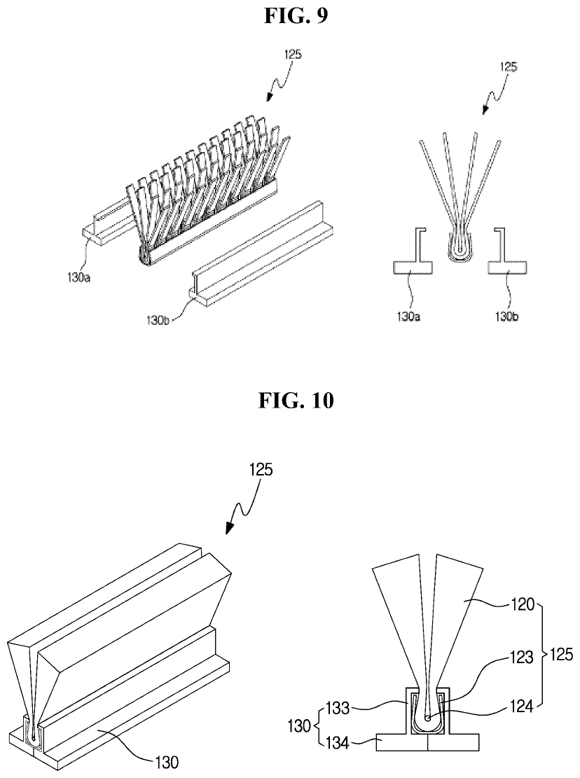

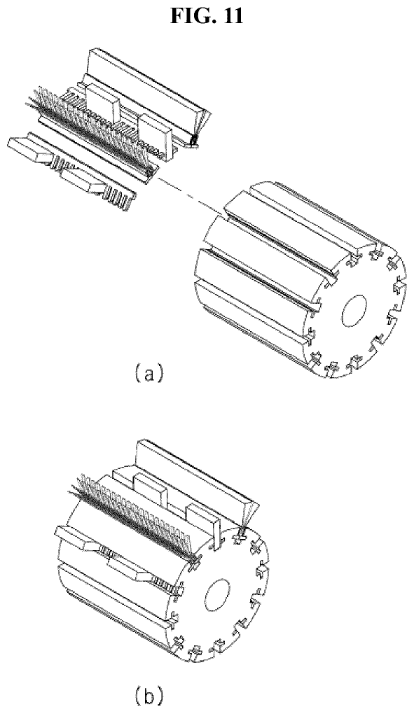

FIG. 6 is a perspective view of a cleaning brush for a hull according to a third embodiment of the present invention, FIG. 7 is an exploded perspective view illustrating a state where a strip brush is separated from the cleaning brush shown in FIG. 6, FIG. 8 illustrates a perspective view and a side view of a coupling state between a filament-shaped strip brush and a fixing part, FIG. 9 illustrates a perspective view and a side view of a separation state between the filament-shaped strip brush and the fixing part shown in FIG. 8, and FIG. 10 illustrates a perspective view and a side view of a coupling state between a fixing part and a sponge-like strip brush of the filament-shaped strip brush shown in FIG. 8 according to another embodiment.

The cleaning brushes for a hull according to the embodiments to be described below are substantially similar to those described above. As such, repeated descriptions of substantially the same elements will be omitted to avoid redundancy, and the following description focuses on differences from the embodiments described above.

In the present embodiment, the base material 120 is not solely coupled to the fixing part 130, but forms a strip brush 125 together with a holding frame 123 and a core 124. As illustrated in the side views of FIGS. 7 and 8, the strip brush 125 may include the base materials 120 bent symmetrically, the holding frame 123 surrounding a bent lower end part of the base material 120, and the core 124 pressurizing a bent inner side of the base material 120 downward. At this time, as illustrated in the drawings, it is possible to overlap and bend a plurality of base materials 120.

The base material 120 can be cut up and down into a plurality of base materials in a width direction on both sides of a bent portion to form a filament-shaped strip brush 125, as illustrated in FIG. 9. In addition, the base material 120 can also form an uncut sponge-like strip brush 125, as illustrated in FIG. 10. Both sides of the base material 120 of the sponge-like strip brush 125 may be formed to become thicker towards an opposite side of the bent portion.

The base material 120 constituting the strip brush 125 includes preferably a softer material than the aforementioned block-shaped base material 120. In this manner, the strip brush 125 according to an embodiment can be effectively used in cleaning for levels 1 and 2 biofouling.

The fixing part 130 may be coupled to a lower end part of the strip brush 125. As illustrated in the drawings, an accommodation part 133 surrounding an outer side of the holding frame 123 and bent toward the base material above the holding frame 123 may be coupled to a lower end part of the strip brush 125. Fixing protrusions 134 may be formed to protrude on both right and sides of the accommodation part 133. In the drawings, fixing protrusions 134 are exemplarily illustrated as being formed at lowest ends of the left and right sides, but the inventive concepts are not necessarily limited thereto. In some embodiments, the fixing protrusions 134 may be formed to protrude in the middle part of the accommodation part 133.

The fixing part 130 may be separated into right and left parts as illustrated in the drawings. When the fixing part 130 is integrally formed as a single piece, it is difficult to easily insert the lower end part of the strip brush 125 into the accommodation part 133 of the fixing part 130. According to an embodiment, by forming the fixing part 130 to have right and left parts that may be decoupled, the lower end part of the strip brush 125 can be easily inserted into the accommodation part 133.

The rotation body part 110 has the fixing grooves 116 formed as described above, and the fixing parts 130 coupled to the respective strip brushes 125 can be inserted into the fixing grooves 116 so that the strip brushes 125 can be easily replaced and installed.

The drawings exemplarily illustrate that the strip brushes 125 are coupled to the side surface of the cylinder, but the inventive concepts are not limited thereto. In some embodiment, the strip brush 125 may be coupled to the rotation body part 110 having a circular disk shape as illustrated in FIGS. 1 and 2.

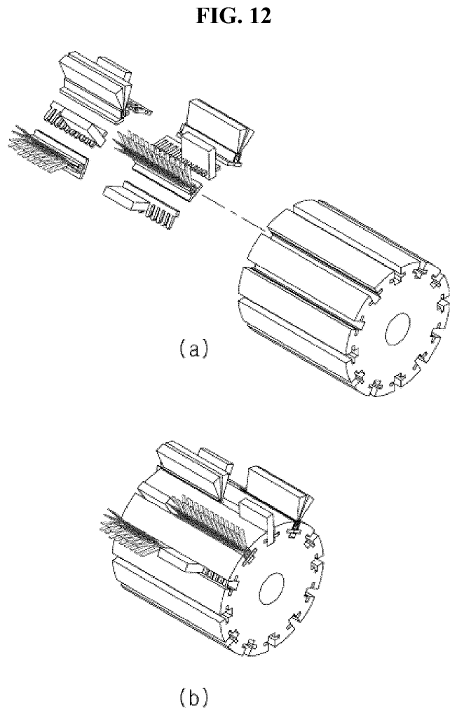

FIG. 11 illustrates an exploded perspective view and a coupling view of a cleaning brush for a hull according to a fourth embodiment of the present invention, and FIG. 12 illustrates an exploded perspective view and a coupling view of a cleaning brush for a hull according to a fourth embodiment according to another embodiment.

In the present embodiment, as illustrated in FIG. 11, the base materials 120 having shapes different from each other or including materials different from each other as described with reference to FIGS. 1 to 10 may be individually inserted into the plurality of fixing grooves 116. The block-shaped base materials 120 illustrated with reference to FIGS. 1 to 5, or the base materials 120 having a shape of the strip brush 125 described with reference to FIGS. 6 to 10, can be arranged individually in each of the plurality of grooves 116 arranged in the circumferential direction. Alternatively, as illustrated in FIG. 12, the base materials 120 having shapes different from each other or including materials different from each other can be individually inserted into one fixing groove 116 along an insertion direction.

In this case, for level 1 biofouling, it is possible to remove the contaminants without causing damages to the antifouling paint by using the base material 120 having the shape of the strip brush 125 made of soft material, and for levels 2 and 3 biofouling, it is possible to remove contaminants without causing damages to the antifouling paint by using the block-shaped base material 120 made of hard material. Further, for level 4 biofouling, it is possible to remove contaminants while damage to the antifouling paint is minimized by using a block-shaped base material 120 in which metal is mixed or which includes a metal material. As such, according to embodiments, various types of base materials 120 are mounted on the rotation body part 110 so that contaminants can be removed by a single cleaning brush without using an additional cleaning brush according to the degree of fouling.

In addition, in order to improve cleaning performance for level 1 biofouling, the surface of the base material 120 according to an embodiment can be coated with powder of carbon or a metal material having a high hardness. Alternatively, the base material 120 can be formed by mixing powder of carbon or metal material having a high hardness. When a powder is mixed or coated on a material of the base material 120 that has a hard and smooth surface, such as urethane or filament, or a tender and soft material, such as sponge, the surface of the base material 120 may be roughed, which may improve the cleaning performance for level 1 biofouling, such as slime.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art

1. A cleaning brush for a hull for removing contaminants on a surface of a hull, comprising:
a base material;
a fixing part coupled to a lower end part of the base material and having a fixing protrusion that protrudes from an outside of the base material; and
a rotation body part having at least one fixing groove into which the fixing part coupled to the base material is to be inserted,
wherein the base material is replaceable.

2. The cleaning brush for a hull according to claim 1, wherein:
the rotation body part has a disk shape;
the fixing groove has a shape open at a side surface part and an upper surface of the rotation body part; and
the fixing part coupled to the base material is configured to be inserted inward in a radial direction through the fixing groove from a side surface of the rotation body part.

3. The cleaning brush for a hull according to claim 1, wherein:
the rotation body part has a cylinder shape;
the fixing groove has a shape open at an outer surface and an edge of at least one surface of upper and lower surfaces of the rotation body part; and
the fixing part coupled to the base material is configured to be inserted in a height direction of the rotation body part from any one surface of the upper and lower surfaces of the rotation body part.

4. The cleaning brush for a hull according to claim 1, wherein:
the fixing groove comprises:
a fixing protrusion inserting groove into which the fixing protrusion is configured to be inserted; and
a base material inserting groove into which the lower end part of the base material is configured to be inserted; and.

5. The cleaning brush for a hull according to claim 1, wherein the base material has a block shape or comprises a plurality of plates overlapping one another.

6. The cleaning brush for a hull according to claim 5, wherein:
the lower end part of the base material has at least one penetration hole; and
the fixing part has a fixing protrusion configured to be inserted into the penetration hole and protrudes toward both sides from the penetration hole.

7. The cleaning brush for a hull according to claim 6, wherein:
the fixing part comprises:
a bar-shaped first frame; and
at least one bar-shaped second frame extending in a direction orthogonal to the first frame and protruding to an outer side from the base material.

8. The cleaning brush for a hull according to claim 5, wherein the base material comprises a polyurethane class or a nylon class.

9. The cleaning brush for a hull according to claim 1, further comprising:
a strip brush including a base material having a symmetrically bent shape;
a holding frame surrounding a bent lower end part of the base material; and
a core pressurizing a bent inner side of the base material,
wherein the fixing part is coupled to a lower end part of the strip brush.

10. The cleaning brush for a hull according to claim 9, wherein:
the fixing part has an accommodation part that surrounds an outer side of the holding frame, and an upper end part bent above the holding frame; and
the fixing protrusion protrudes toward both sides from an outer surface of the accommodation part.

11. The cleaning brush for a hull according to claim 9, wherein the strip brush comprises a filament-shaped strip brush or a sponge-like strip brush.

12. The cleaning brush for a hull according to claim 10, wherein the fixing part comprises right and left parts detachably coupled to each other.

13. The cleaning brush for a hull according to claim 1, wherein base materials having shapes different from each other and including materials different from each other are inserted into a plurality of fixing grooves, respectively.

14. The cleaning brush for a hull according to claim 1, wherein base materials having shapes different from each other and including materials different from each other are inserted into the fixing grooves, respectively, along insertion directions of the fixing grooves.

15. The cleaning brush for a hull according to claim 1, wherein a surface of the base material is coated with powder having a high hardness.

16. The cleaning brush for a hull according to claim 1, wherein the base material comprises powder having a high hardness.

17. The cleaning brush for a hull according to claim 15, wherein the powder comprises carbon or metal.

18. The cleaning brush for a hull according to claim 16, wherein the powder comprises carbon or metal.
